(19) United States
(12) Patent Application Publication
(10) Pub. No.: US 2026/0246092 A1
(43) Pub. Date: Aug. 20, 2026

(54) SECONDARY BATTERY AND ELECTRONIC APPARATUS

(71) Applicant: Dongguan Amperex Technology Limited, Dongguan (CN)

(72) Inventor: Shaojun HUANG, Dongguan (CN)

(73) Assignee: Dongguan Amperex Technology Limited, Dongguan (CN)

(21) Appl. No.: 19/640,626

(22) Filed: Apr. 7, 2026

Related U.S. Application Data
(63) Continuation of application No. PCT/CN2023/123444, filed on Oct. 8, 2023.

(51) Int. Cl. H01M 50/46; H01M 50/434; H01M 50/443

(52) U.S. Cl. CPC H01M 50/461; H01M 50/434; H01M 50/443

(57) ABSTRACT

A secondary battery includes an electrode assembly. The electrode assembly is a stacking structure, and the electrode assembly includes a first electrode sheet, a separator, and a second electrode sheet sequentially stacked in a first direction. The first electrode sheet includes a first outer electrode sheet located at one end of the electrode assembly in the first direction and at least one first inner electrode sheet located inside the electrode assembly relative to the first outer electrode sheet. The separator includes a first separator bonded to the first outer electrode sheet and a second separator bonded to the first inner electrode sheet. A bonding strength between the first separator and the first outer electrode sheet is defined as F₁, a bonding strength between the second separator and the first inner electrode sheet is defined as F₂, and F₁>F₂.

### CROSS REFERENCE TO RELATED APPLICATION

This application is a continuation application of International Application No. PCT/CN2023/123444, filed on Oct. 8, 2023, the contents of which are incorporated herein by reference in its entirety.

### TECHNICAL FIELD

This application relates to the field of energy storage technologies, and in particular, to a secondary battery and an electronic apparatus containing the secondary battery.

### BACKGROUND

Secondary batteries (such as lithium-ion batteries) are widely used in electronic products such as electronic mobile devices, electric tools, and electric vehicles. After long-term charge-discharge cycles, lithium is precipitated on a surface of a negative electrode sheet of the secondary battery to form lithium dendrites, and the lithium dendrites easily pierce a separator to cause short-circuit failure, thereby affecting reliability and a service life of the secondary battery.

### SUMMARY

In view of this, it is necessary to provide a secondary battery that can improve reliability and a service life.

In addition, it is also necessary to provide an electronic apparatus containing the above secondary battery.

In a first aspect of this application, a secondary battery is provided, including an electrode assembly. The electrode assembly is a stacking structure, and the electrode assembly includes a first electrode sheet, a separator, and a second electrode sheet sequentially stacked in a first direction. The first electrode sheet includes a first outer electrode sheet located at one end of the electrode assembly in the first direction and at least one first inner electrode sheet located inside the electrode assembly relative to the first outer electrode sheet. The separator includes a first separator bonded to the first outer electrode sheet and a second separator bonded to the first inner electrode sheet. A bonding strength between the first separator and the first outer electrode sheet is defined as F₁, a bonding strength between the second separator and the first inner electrode sheet is defined as F₂, and F₁>F₂.

In this application, the bonding strength between the first separator and the first outer electrode sheet is large, so that after hot pressing, the interfaces between the first outer electrode sheet, the first separator, and the corresponding second electrode sheet can be enhanced, an interface gap can be reduced, and a risk of lithium precipitation after long-term charge-discharge cycles can be further reduced. Moreover, since the bonding strength between the second separator and the first inner electrode sheet is smaller, in other words, not all separators have increased bonding strengths in this application, the risk of excessive interface bonding between the first inner electrode sheet, the second separator, and the corresponding second electrode sheet after hot pressing can be reduced, thereby reducing the risk of capacity decay caused by lithium precipitation, black spots, and the like induced by untimely electrolyte replenishment.

In some possible implementations, F₁≥1.2F₂, so that the bonding strength between the first separator and the first outer electrode sheet is larger, which enhances the interfaces between the first outer electrode sheet, the first separator, and the corresponding second electrode sheet, and reduces the risk of lithium precipitation after long-term charge-discharge cycles.

In some possible implementations, 4F₂≥F₁≥1.5F₂. The lower limit value of F₁ relative to F₂ is further defined, which enhances the interfaces between the first outer electrode sheet, the first separator, and the corresponding second electrode sheet, and reduces the risk of lithium precipitation after long-term charge-discharge cycles. In addition, the upper limit value of F₁ relative to F₂ is defined, reducing the risk of excessive interface bonding between the first outer electrode sheet, the first separator, and the corresponding second electrode sheet, thereby reducing the risk of capacity decay caused by lithium precipitation, black spots, and the like induced by untimely electrolyte replenishment.

In some possible implementations, 10 N/m≥F₂≥4 N/m. The lower limit value of F₂ is defined, so that the interfaces between the first inner electrode sheet, the second separator, and the corresponding second electrode sheet can be enhanced, and the risk of lithium precipitation after long-term charge-discharge cycles can be reduced. The upper limit value of F₂ is defined, so that the risk of excessive interface bonding between the first inner electrode sheet, the second separator, and the corresponding second electrode sheet can be reduced, reducing the risk that excessive F₁ leads to excessive interface bonding between the first outer electrode sheet, the first separator, and the corresponding second electrode sheet, thereby reducing the risk of capacity decay caused by lithium precipitation, black spots, and the like induced by untimely electrolyte replenishment.

In some possible implementations, the first separator includes a first substrate layer and a first bonding layer stacked in the first direction, and the first bonding layer is disposed facing the first outer electrode sheet. The second separator includes a second substrate layer and a second bonding layer stacked in the first direction, and the second bonding layer is disposed facing the first inner electrode sheet. A first binder is provided in the first bonding layer, and a second binder is provided in the second bonding layer. The first binder is used to increase the interface bonding strength between the first separator and the first outer electrode sheet, and the second binder is used for increasing the interface bonding strength between the second separator and the first inner electrode sheet.

In some possible implementations, the first binder and the second binder are of a same type, and a mass content of the first binder in the first bonding layer is greater than a mass content of the second binder in the second bonding layer, so that the bonding strength between the first separator and the first outer electrode sheet is greater than the bonding strength between the second separator and the first inner electrode sheet.

In some possible implementations, the first binder is selected from one or a combination of polyvinylidene fluoride, vinylidene fluoride-hexafluoropropylene copolymer, polyamide, polyacrylonitrile, polyacrylate ester, polyacrylic acid, polyacrylate salt, polyvinylpyrrolidone, polyvinyl ether, polymethyl methacrylate, polytetrafluoroethylene, and polyhexafluoropropylene. In some possible implementations, the second binder is selected from one or a combination of polyvinylidene fluoride, vinylidene fluoride-hexafluoropropylene copolymer, polyamide, polyacrylonitrile, polyacrylate ester, polyacrylic acid, polyacrylate salt, polyvinylpyrrolidone, polyvinyl ether, polymethyl methacrylate, polytetrafluoroethylene, and polyhexafluoropropylene.

In some possible implementations, a material of the first substrate layer is selected from at least one of polyolefin, polyvinylidene fluoride, polyethylene terephthalate, cellulose, polyimide, polyamide, spandex, or poly(phenylene phthalamide). In some possible implementations, a material of the second substrate layer is selected from at least one of polyolefin, polyvinylidene fluoride, polyethylene terephthalate, cellulose, polyimide, polyamide, spandex, or poly(phenylene phthalamide).

In some possible implementations, at least one of the first bonding layer or the second bonding layer further includes inorganic particles. The inorganic particles are selected from at least one of aluminum oxide, silicon oxide, magnesium oxide, titanium oxide, hafnium dioxide, tin oxide, cerium dioxide, nickel oxide, zinc oxide, calcium oxide, zirconium oxide, yttrium oxide, silicon carbide, boehmite, aluminum hydroxide, magnesium hydroxide, calcium hydroxide, or barium sulfate. The inorganic particles are used to improve heat resistance and puncture resistance of the separator.

In some possible implementations, the first electrode sheet is a positive electrode sheet. Since a potential of the positive electrode sheet is relatively high, the inorganic particles can protect the first substrate layer or the second substrate layer from being oxidized by the positive electrode sheet.

In some possible implementations, the first outer electrode sheet includes a first current collector and a first active material layer stacked in the first direction. The first current collector includes a first surface facing the second electrode sheet and a second surface opposite to the first surface. The first active material layer is disposed on the first surface, and the second surface is not provided with an active material. The first outer electrode sheet is configured as an electrode sheet with one side coated, so that waste of energy density is reduced.

In some possible implementations, the separator further includes a connection section disposed between adjacent second separators, and the second separators are connected to each other through the connection section to form an integral structure. Therefore, the second separator can bind the first inner electrode sheet and the second electrode sheet.

In a second aspect of this application, an electronic apparatus is further provided, including the secondary battery as described above. The electronic apparatus is powered by the above secondary battery, and the lithium precipitation risk of the secondary battery is reduced, which improves safety and prolongs a service life of the secondary battery.

### BRIEF DESCRIPTION OF DRAWINGS

The above and/or additional aspects and advantages of this application will become apparent and easily understood from the description of embodiments with reference to the following drawings, in which:

FIG. 1 is a schematic structural diagram of a secondary battery provided in an embodiment of this application when viewed from a first direction.

FIG. 2 is a cross-sectional view of the secondary battery shown in FIG. 1 along a section line II-II.

FIG. 3 is a cross-sectional view of the secondary battery shown in FIG. 1 along a section line III-III.

FIG. 4 is a cross-sectional view of the secondary battery shown in FIG. 1 along a section line IV-IV in some embodiments.

FIG. 5A is a cross-sectional view of a first separator shown in FIG. 2, FIG. 3, or FIG. 4.

FIG. 5B is a cross-sectional view of a second separator shown in FIG. 2,

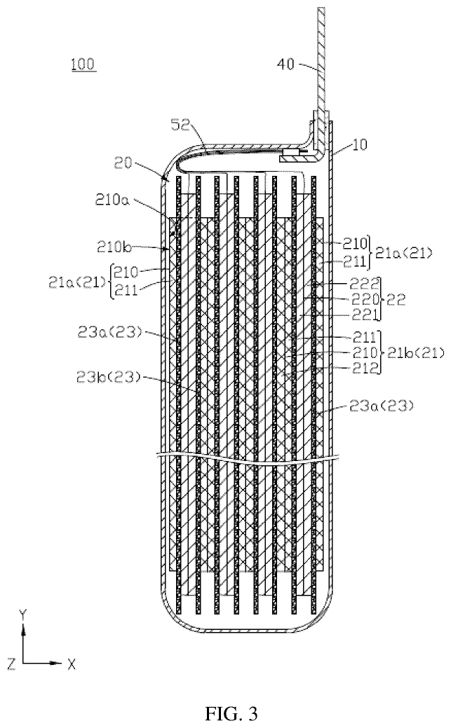

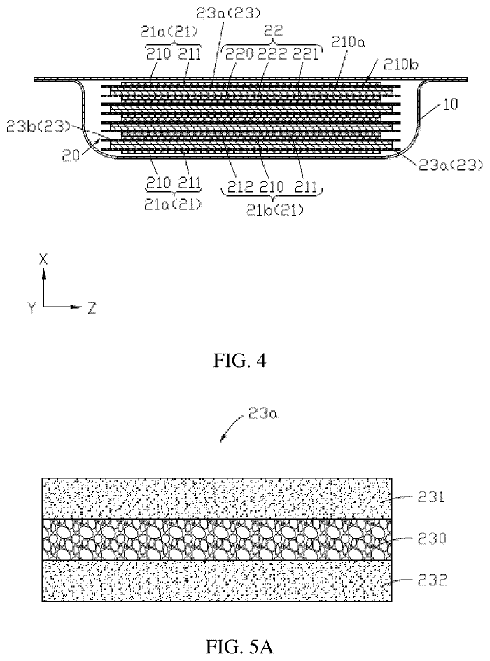

FIG. 3, or FIG. 4.

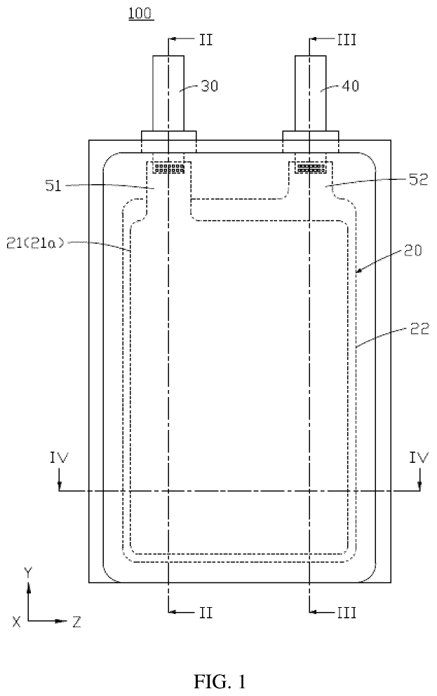

FIG. 6 is a cross-sectional view of the secondary battery shown in FIG. 1 along a section line IV-IV in some other embodiments.

FIG. 7 is a schematic structural diagram of a secondary battery provided in another embodiment of this application when viewed from a first direction.

FIG. 8 is a cross-sectional view of the secondary battery shown in FIG. 7 along a section line VIII-VIII in some embodiments.

FIG. 9 is a cross-sectional view of the secondary battery shown in FIG. 7 along the section line VIII-VIII in some other embodiments.

FIG. 10 is a schematic structural diagram of an electronic apparatus provided in an embodiment of this application.

### DESCRIPTION OF MAIN REFERENCE SIGNS

electronic apparatus 1
housing 10
electrode assembly 20
first electrode sheet 21
first outer electrode sheet 21a
first inner electrode sheet 21b
second electrode sheet 22
separator 23
first separator 23a
second separator 231
first conductive plate 30
second conductive plate 40
first tab 51
second tab 52
secondary battery 100, 200
first current collector 210
first surface 210a
second surface 210b
first active material layer 211
second active material layer 212
second current collector 220
third active material layer 221
fourth active material layer 222
first substrate layer 230
first bonding layer 231
third bonding layer 232
connection section 233
second substrate layer 234
second bonding layer 235
fourth bonding layer 236
first direction X
second direction Y
third direction Z

This application is further illustrated with reference to the above drawings in the following specific embodiments.

### DETAILED DESCRIPTION

The technical solutions in some embodiments of this application are clearly and thoroughly described. It is clear that the described embodiments are some but not all embodiments of this application. Unless otherwise defined, all technical and scientific terms used herein have the same meaning as commonly understood by those of ordinary skill in the art to which this application pertains. The terms used in the specification of this application are for the purpose of describing specific embodiments only and are not intended to limit this application.

Hereinafter, some embodiments of this application are described in detail. However, this application may be embodied in many different forms and should not be construed as limitations to the exemplary embodiments set forth herein. Rather, these exemplary embodiments are provided so that this application will be thorough and complete, and will fully convey the scope of the application to those skilled in the art.

In addition, for brevity and clarity, in the drawings, the dimensions or thicknesses of various components and layers may be exaggerated. Throughout the text, the same signs refer to the same elements. As used herein, the terms “and/or” includes any and all combinations of one or more of the associated listed items. It should also be understood that when an element A is referred to as being “connected” to an element B, the element A may be directly connected to the element B, or the element A and the element B may be indirectly connected to each other through an intermediate element C.

Further, in descriptions of some embodiments of this application, “may” refers to “one or more embodiments of this application”.

The technical terms used herein are for the purpose of describing specific embodiments and are not intended to limit this application. As used herein, a singular form is intended to include a plural form, unless the context clearly indicates otherwise. It should be further understood that the term “include”, when used in this specification, indicates the presence of the features, numbers, steps, operations, elements, and/or components recited, but does not exclude the presence or addition of one or more other features, numbers, steps, operations, elements, components, and/or combinations thereof.

Spatially relative terms, such as “upper” and the like, may be used herein for convenience in description to describe the relationship of one element or feature to another element (or multiple elements) or feature (multiple features) as illustrated in the figures. It should be understood that the spatially relative terms are intended to encompass different orientations of the device or apparatus in use or operation in addition to the orientation depicted in the figures. For example, if the device in the figures is turned over, elements described as “above” or “on” other elements or features are then oriented “below” or “under” the other elements or features. Thus, the exemplary term “above” may include both orientations indicated by “above” and “below”. It should be understood that, although the terms “first”, “second”, “third”, and the like may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of the exemplary embodiments.

As used herein, “parallel” and “perpendicular” are used to describe ideal states between two components. In actual production or use states, there may be states approximately parallel or perpendicular between two components. For example, in numerical descriptions, being parallel may mean an angle range of ±10° between two straight lines, or a dihedral angle range of ±10° between two planes, or an angle range of ±10° between a straight line and a plane; being perpendicular may mean an angle range of 90°±10° between two straight lines, or a dihedral angle range of 90°±10° between two planes, or an angle range of 90°±10° between a straight line and a plane. Two components described as “parallel” or “perpendicular” may not be absolute straight lines or planes, and may be roughly straight lines or planes, and from a macroscopic perspective, as long as the overall extension direction is a straight line or plane, the component may be considered as “straight line” or “plane”.

In this application, the terms “greater than”, “less than”, or “unequal” describing relationships between parameter values are intended to exclude reasonable errors of the measurement equipment.

After the secondary battery undergoes long-term charge-discharge cycles, lithium may be precipitated on a surface of an electrode sheet of a lithium-ion secondary battery, especially a negative electrode sheet, to form lithium dendrites. The lithium dendrites may pierce a separator between the negative electrode sheet and a positive electrode sheet, causing the negative electrode sheet and the positive electrode sheet to directly contact and cause short-circuit failure. Especially for secondary batteries with a stacking structure, an outer electrode sheet is more prone to lithium precipitation after charge-discharge cycles. The inventor of this application has studied the causes of lithium precipitation in secondary batteries with a stacking structure and found that the lithium precipitation in the secondary battery with a stacking structure is closely related to the stacking structure and its manufacturing process.

In the hot pressing process after stacking, considering that an outermost electrode sheet (such as the positive electrode sheet) may be damaged due to direct contact with a hot pressing platen, hot pressing may be performed for the first time on the other parts of the electrode assembly except the outer positive electrode sheet, and then the outer positive electrode sheet is stacked on a structure obtained through the first hot pressing step and then hot pressed for the second time. However, the inventor of this application has found that since the outer positive electrode sheet only undergoes hot pressing one time, duration of the hot pressing is short, and the temperature is low, the interface contact between the outer positive electrode sheet and the separator adjacent to the outer positive electrode sheet is not tight, and the negative electrode sheet adjacent to the outer positive electrode sheet is prone to precipitate lithium after long-term charge-discharge cycles.

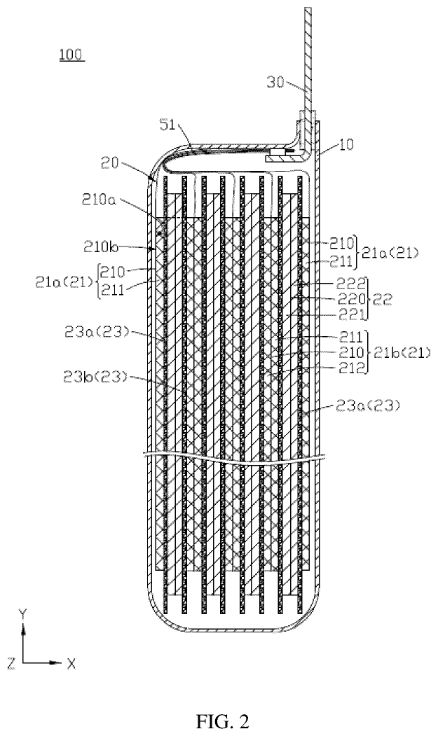

For the causes of lithium precipitation in the secondary battery with a stacking structure discovered by the research of the inventor of this application, refer to FIG. 1 to FIG. 4. An embodiment of this application provides a secondary battery 100, including a housing 10, an electrode assembly 20, and an electrolyte (not shown) disposed in the housing 10, a first conductive plate 30, and a second conductive plate 40. As shown in FIG. 2 to FIG. 4, the electrode assembly 20 is a stacking structure, including a plurality of first electrode sheets 21, a plurality of second electrode sheets 22, and a plurality of separators 23. In the stacking structure, the first electrode sheets 21 and the second electrode sheets 22 are alternately stacked in sequence, a second electrode sheet 22 is provided between any two adjacent first electrode sheets 21, and a first electrode sheet 21 is provided between each two adjacent second electrode sheets 22. The separator 23 is disposed between adjacent first electrode sheet 21 and second electrode sheet 22, and the separator 23 is used to prevent direct contact between the first electrode sheet 21 and the second electrode sheet 22, thereby reducing the possibility of short circuit caused by contact between the first electrode sheet 21 and the second electrode sheet 22. As shown in FIG. 2, the first conductive plate 30 is electrically connected to the first electrode sheet 21. As shown in FIG. 3, the second conductive plate 40 is electrically connected to the second electrode sheet 22. Both the first conductive plate 30 and the second conductive plate 40 extend from one end of the housing 10, and the first conductive plate 30 and the second conductive plate 40 are used to connect to an external device (not shown). The housing 10 may be a packaging bag obtained through packaging with a packaging film (such as an aluminum-plastic film), that is, the secondary battery 100 may be a pouch battery. In some other embodiments, the secondary battery 100 is not limited to a pouch battery, and may alternatively be a steel shell battery, an aluminum shell battery, or the like.

A three-dimensional coordinate system is established based on a first direction X, a second direction Y, and a third direction Z that are perpendicular to each other. In the description of the embodiments of this application, the first direction X is a stacking direction of the first electrode sheet 21, the separator 23, and the second electrode sheet 22; the second direction Y is the direction in which the first conductive plate 30 or the second conductive plate 40 extends beyond the housing 10, and also a direction in which the first conductive plate 30 or the second conductive plate 40 protrudes from the electrode assembly 20; the third direction Z is a direction from the first conductive plate 30 to the second conductive plate 40.

As shown in FIG. 2 to FIG. 4, the plurality of first electrode sheets 21 include a first outer electrode sheet 21a located at one end of the electrode assembly 20 in the first direction X and at least one first inner electrode sheet 21b on an inner side of the first outer electrode sheet 21a. In some embodiments, the plurality of first electrode sheets 21 include two first outer electrode sheets 21a located at both ends of the electrode assembly 20 in the first direction X and a plurality of first inner electrode sheets 21b located between the two first outer electrode sheets 21a. That is, the outermost electrode sheets in the plurality of first electrode sheets 21 are two first outer electrode sheets 21a, and the inner electrode sheets in the plurality of first electrode sheets 21 are a plurality of first inner electrode sheets 21b. In the first direction X, the second electrode sheet 22 and the separator 23 may be located between the two first outer electrode sheets 21a, so the two first outer electrode sheets 21a may constitute the outermost layers of the electrode assembly 20.

In some embodiments, the first outer electrode sheet 21a is an electrode sheet with one side coated. The first outer electrode sheet 21a includes a first current collector 210 and a first active material layer 211 stacked in the first direction X. The first current collector 210 includes a first surface 210a facing the second electrode sheet 22 and a second surface 210b opposite to the first surface 210a. The first active material layer 211 is disposed on the first surface 210a, and the second surface 210b is not provided with an active material. The first inner electrode sheet 21b is an electrode sheet with two sides coated. The first inner electrode sheet 21b includes a first active material layer 211, a first current collector 210, and a second active material layer 212 stacked in the first direction X. The first electrode sheet 21 may be a positive electrode sheet. Correspondingly, the first current collector 210 may be a positive electrode current collector, and the first active material layer 211 and the second active material layer 212 may both be positive electrode active material layers. The active material contained in the first active material layer 211 or the second active material layer 212 of the first inner electrode sheet 21b may be the same as or different from the active material contained in the first active material layer 211 of the first outer electrode sheet 21a. The first outer electrode sheet 21a is configured as an electrode sheet with one side coated, so that waste of energy density is reduced. When the first electrode sheet 21 is a positive electrode sheet, the possibility of excessive lithium ions accumulation and lithium precipitation due to failure of the second electrode sheet 22 in intercalation of corresponding lithium ions (such as lithium ions deintercalate from the active material provided for the second surface 210b) can also be reduced.

The second electrode sheet 22 may be an electrode sheet with two sides coated. The second electrode sheet 22 includes a third active material layer 221, a second current collector 220, and a fourth active material layer 222 that are stacked. The third active material layer 221 is disposed facing the first active material layer 211 with the separator 23 interposed therebetween, and the fourth active material layer 222 is disposed facing the second active material layer 212 with the separator 23 interposed therebetween. The second electrode sheet 22 may be a negative electrode sheet. Correspondingly, the second current collector 220 may be a negative electrode current collector, and the third active material layer 221 and the fourth active material layer 222 may both be negative electrode active material layers. A plurality of first tabs 51 and a plurality of second tabs 52 may be provided on the electrode assembly 20. The plurality of first tabs 51 are integrally connected to the first current collector 210. The plurality of second tabs 52 are integrally connected to the second current collector 220. The first tab 51 is welded to the first conductive plate 30 through an adapter welding process, and the second tab 52 is welded to the second conductive plate 40 through adapter welding.

The positive electrode current collector may be aluminum foil or nickel foil, and the negative electrode current collector may be at least one of copper foil, nickel foil, or carbon-based current collector. The positive electrode active material layer includes a positive electrode active material, and the positive electrode active material includes a compound (lithium intercalation compound) where lithium ions reversibly intercalate and deintercalate. In some embodiments, the positive electrode active material may include a lithium transition metal composite oxide. The lithium transition metal composite oxide contains lithium and at least one element selected from cobalt, manganese, and nickel. In some embodiments, the positive electrode active material is selected from at least one of lithium cobaltate (LiCoO₂), lithium nickel manganese cobalt ternary material (NCM), lithium manganate (LiMn₂O₄), lithium manganese nickel oxide (LiNi_{0.5}Mn_{1.5}O₄), or lithium iron phosphate (LiFePO₄). The negative electrode active material layer includes a negative electrode active material, and a negative electrode active material where active ions reversibly deintercalate known in the art is adopted, which is not limited in this application. For example, it may be one or a combination of graphite, soft carbon, hard carbon, carbon fibers, mesophase carbon microspheres, silicon-based material, tin-based material, lithium titanate, other metals that can form alloys with lithium, or the like. The graphite may be selected from one or a combination of artificial graphite, natural graphite, and modified graphite; the silicon-based material may be selected from one or a combination of elemental silicon, silicon oxide, silicon-carbon composite, and silicon alloy; and the tin-based material may be selected from one or a combination of elemental tin, tin oxide, tin alloy, or the like.

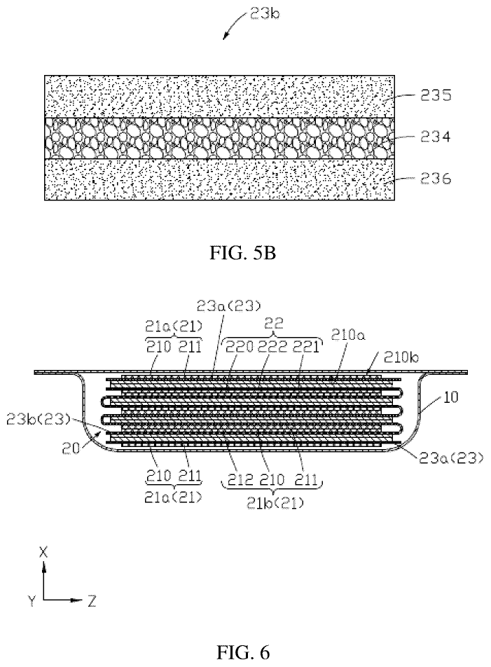

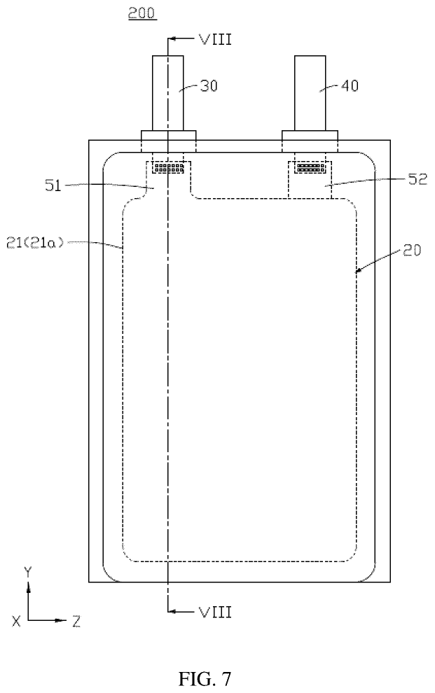

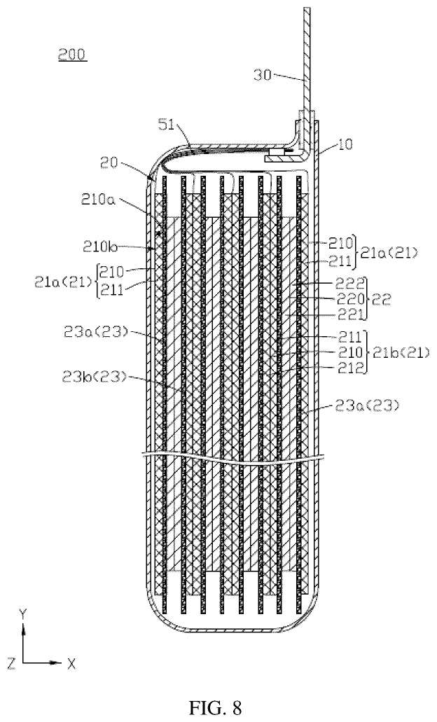

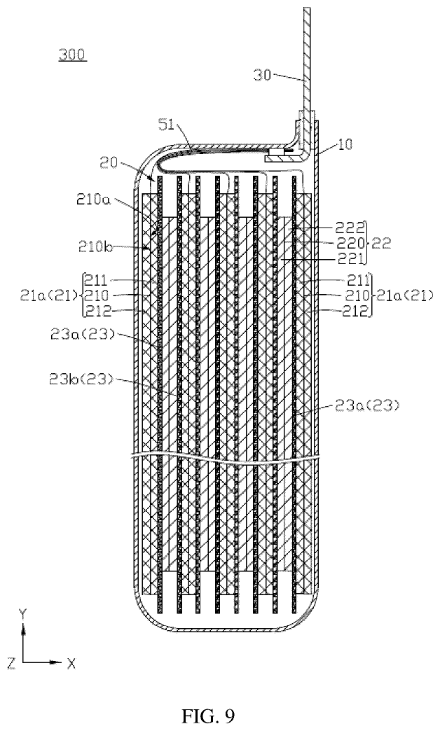

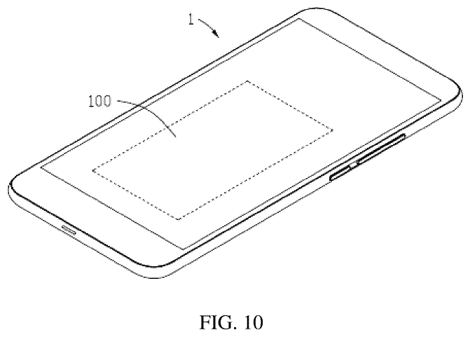

The plurality of separators 23 include a first separator 23a bonded to the first outer electrode sheet 21a and a second separator 23b bonded to the first inner electrode sheet 21b. A quantity of the first separators 23a is the same as a quantity of the first outer electrode sheets 21a. For example, when two first outer electrode sheets 21a are provided, two first separators 23a are provided. In the first direction X, each second separator 23b is located between two first separators 23a. As shown in FIG. 5A, the first separator 23a may be a multi-layer structure, including a first bonding layer 231, a first substrate layer 230, and a third bonding layer 232 stacked in the first direction X. The first bonding layer 231 is disposed facing the first outer electrode sheet 21a, and the first separator 23a bonds to the first active material layer 211 of the first outer electrode sheet 21a through the first bonding layer 231. The third bonding layer 232 is disposed facing the second electrode sheet 22. The first substrate layer 230 is a porous structure, including at least one of polyolefin, polyvinylidene fluoride, polyethylene terephthalate, cellulose, polyimide, polyamide, spandex, or poly(phenylene phthalamide). For example, the polyolefin may be polyethylene, and the polyethylene includes at least one selected from high-density polyethylene, low-density polyethylene, or ultra-high molecular weight polyethylene. The first bonding layer 231 and the third bonding layer 232 are also porous structures. A first binder is provided in the first bonding layer 231, and a third binder is provided in the third bonding layer 232. The first binder is used to increase the interface bonding strength between the first separator 23a and the first outer electrode sheet 21a, and the third binder is used for increasing the interface bonding strength between the first separator 23a and the second electrode sheet 22.

As shown in FIG. 5B, the second separator 23b may be a multi-layer structure, including a second bonding layer 235, a second substrate layer 234, and a fourth bonding layer 236 stacked in the first direction X. The second bonding layer 235 is disposed facing the first inner electrode sheet 21b, and the second separator 23b bonds to the first active material layer 211 or the second active material layer 212 of the first inner electrode sheet 21b through the second bonding layer 235. The fourth bonding layer 236 is disposed facing the second electrode sheet 22. The second substrate layer 234 is a porous structure, including at least one of polyolefin, polyvinylidene fluoride, polyethylene terephthalate, cellulose, polyimide, polyamide, spandex, or poly(phenylene phthalamide). The second bonding layer 235 and the fourth bonding layer 236 are also porous structures. A second binder is provided in the second bonding layer 235, and a fourth binder is provided in the fourth bonding layer 236. The second binder is used to increase the interface bonding strength between the second separator 23b and the first inner electrode sheet 21b, and the fourth binder is used for increasing the interface bonding strength between the second separator 23b and the second electrode sheet 22.

In some embodiments, at least one of the first bonding layer 231 or the second bonding layer 235 may further include inorganic particles, which are used to improve heat resistance and puncture resistance of the separator 23. When the first electrode sheet 21 is a positive electrode sheet, since a potential of the positive electrode sheet is relatively high, inorganic particles can protect the first substrate layer 230 or the second substrate layer 234 from being oxidized by the positive electrode sheet. In some embodiments, at least one of the third bonding layer 232 or the fourth bonding layer 236 may also be provided with inorganic particles. The inorganic particles are selected from at least one of aluminum oxide, silicon oxide, magnesium oxide, titanium oxide, hafnium dioxide, tin oxide, cerium dioxide, nickel oxide, zinc oxide, calcium oxide, zirconium oxide, yttrium oxide, silicon carbide, boehmite, aluminum hydroxide, magnesium hydroxide, calcium hydroxide, or barium sulfate.

The bonding strength between the first separator 23a and the first outer electrode sheet 21a is defined as F₁, the bonding strength between the second separator 23b and the first inner electrode sheet 21b is defined as F₂, and F₁>F₂. Specifically, in some embodiments of this application, the second separator 23b may be a separator used in a conventional secondary battery with a stacking structure, while the first separator 23a may be a separator with a higher bonding strength, so that the bonding strength F₁ between the first separator 23a and the first outer electrode sheet 21a is greater than the bonding strength F₂ between the second separator 23b and the first inner electrode sheet 21b.

In some embodiments, the first binder and the second binder are of a same type, and a mass content of the first binder in the first bonding layer 231 is greater than a mass content of the second binder in the second bonding layer 235, so that the bonding strength F₁ between the first separator 23a and the first outer electrode sheet 21a is greater than a bonding strength F₂ between the second separator 23b and the first inner electrode sheet 21b. The first binder of the first separator 23a may be selected from one or a combination of polyvinylidene fluoride, vinylidene fluoride-hexafluoropropylene copolymer, polyamide, polyacrylonitrile, polyacrylate ester, polyacrylic acid, polyacrylate salt, polyvinylpyrrolidone, polyvinyl ether, polymethyl methacrylate, polytetrafluoroethylene, and polyhexafluoropropylene. The second binder of the second separator 23b is selected from one or a combination of polyvinylidene fluoride, vinylidene fluoride-hexafluoropropylene copolymer, polyamide, polyacrylonitrile, polyacrylate ester, polyacrylic acid, polyacrylate salt, polyvinylpyrrolidone, polyvinyl ether, polymethyl methacrylate, polytetrafluoroethylene, and polyhexafluoropropylene. For example, the first binder is polyvinylidene fluoride (PVDF). Since the crystalline region of PVDF is a semi-crystalline region and has a distinct melting peak at 140° C. to 150° C., the mass content of PVDF can be calculated based on the melting peak of PVDF in this application. Specifically, a method for measuring the PVDF content may include the following steps: (1) The first bonding layer 231 is separated from the first separator 23a to obtain an agglomerated powder with a mass of M; (2) a Mettler differential scanning calorimeter DSC is used to measure a melting peak of the agglomerated powder with a mass of M, and heat E absorbed during PVDF melting is obtained through integration of the melting peak at 140° C. to 150° C.; (3) a mass M1 of PVDF is calculated, and M1=E/(Hm×η), where Hm is a melting enthalpy of fully crystalline PVDF, which is 104.7 J/g, and n is a crystallinity of PVDF, which is 49.5%. When the second binder is PVDF, the content can also be determined by using the same method. It can be understood that when other binders are used in the bonding layers, the above content measurement method can also be set correspondingly based on the properties of the binders.

In some other embodiments, the type of the first binder in the first separator 23a may be different from the type of the second binder in the second separator 23b. For example, a binder with a larger bonding strength may be used for the first separator 23a, or a mass content of an auxiliary may be adjusted, so that the bonding strength F₁ between the first separator 23a and the first outer electrode sheet 21a is greater than the bonding strength F₂ between the second separator 23b and the first inner electrode sheet 21b

The test steps of the bonding strength F₁ include: (1) The electrode assembly 20 is taken out from the housing 10 of the secondary battery 100, and the first outer electrode sheet 21a and the first separator 23a bonded to the first outer electrode sheet 21a are removed and then cut into a test strip of 7 cm×1.5 cm; (2) the first outer electrode sheet 21a of the test strip is fixed on a steel plate with double-sided tape, and the first separator 23a of the test strip is pasted to a 3M tape; (3) a tensile strength testing machine is used to slowly tear the 3M tape from a surface of the test strip at a speed of 50 mm/min at a 180° angle, so that the first separator 23a is completely separated from the first outer electrode sheet 21a; the stable pulling force upon the above interface separation is recorded; and the bonding strength F₁ between the first separator 23a and the first outer electrode sheet 21a is calculated based on the above pulling force and a dimension of a long side of the test strip. To ensure the accuracy of the test results, each test strip can be tested multiple times, for example, 3 times, and then the average is taken. The test steps for the bonding strength F₂ are the same.

In a hot pressing process after stacking, hot pressing may be performed for the first time on the other parts (including the separator 23, the first inner electrode sheet 21b, and the second electrode sheet 22 in the electrode assembly 20) of the electrode assembly 20 except the first outer electrode sheet 21a, and then the first outer electrode sheet 21a is stacked on the structure obtained through the first hot pressing step and then hot pressed for the second time, thereby reducing the risk of damage to the first outer electrode sheet 21a during hot pressing. After the two hot pressing steps, two opposite surfaces of the first separator 23a in the first direction X are bonded to the first outer electrode sheet 21a and the corresponding second electrode sheet 22 respectively, and two opposite surfaces of the second separator 23b in the first direction X are bonded to the first inner electrode sheet 21b and the corresponding second electrode sheet 22 respectively. The above descriptions are only an example of a hot pressing process performed on the electrode assembly 20, but the hot pressing process that may be performed in this application is not limited thereto.

In this application, the bonding strength F₁ between the first separator 23a and the first outer electrode sheet 21a is greater than the bonding strength F₂ between the second separator 23b and the first inner electrode sheet 21b. Since the bonding strength F₁ between the first separator 23a and the first outer electrode sheet 21a is larger, even if the same two-step hot pressing process as in the related art is used to process the electrode assembly 20 obtained through stacking, the interfaces between the first outer electrode sheet 21a, the first separator 23a, and the corresponding second electrode sheet 22 can be enhanced, an interface gap can be reduced, and the risk of lithium precipitation after long-term charge-discharge cycles can be further reduced. Moreover, since the bonding strength F₂ between the second separator 23b and the first inner electrode sheet 21b is smaller, in other words, not all separators 23 have increased bonding strengths in this application, the risk of excessive interface bonding between the first inner electrode sheet 21b, the second separator 23b, and the corresponding second electrode sheet 22 after hot pressing can be reduced, thereby reducing the risk of capacity decay caused by lithium precipitation, black spots, and the like induced by untimely electrolyte replenishment.

In some embodiments, F₁≥1.2F₂. The lower limit value of F₁ relative to F₂ is further defined, so that the bonding strength F₁ between the first separator 23a and the first outer electrode sheet 21a is larger, which enhances the interfaces between the first outer electrode sheet 21a, the first separator 23a, and the corresponding second electrode sheet 22, and reduces the risk of lithium precipitation after long-term charge-discharge cycles.

Further, in some embodiments, 4F₂≥F₁≥1.5F₂. The lower limit value of F₁ relative to F₂ is further defined, so that the bonding strength F₁ between the first separator 23a and the first outer electrode sheet 21a is larger, which enhances the interfaces between the first outer electrode sheet 21a, the first separator 23a, and the corresponding second electrode sheet 22, and reduces the risk of lithium precipitation after long-term charge-discharge cycles. In addition, the upper limit value of F₁ relative to F₂ is defined, reducing the risk of excessive interface bonding between the first outer electrode sheet 21a, the first separator 23a, and the corresponding second electrode sheet 22, thereby reducing the risk of capacity decay caused by lithium precipitation, black spots, and the like induced by untimely electrolyte replenishment. Moreover, when the bonding strength F₁ is increased by increasing the mass content of the first binder in the first separator 23a, defining the upper limit value of F₁ relative to F₂ can further reduce the risk of blocking pores of the first separator 23a by excessive first binder during the interface formation, facilitating transport of the electrolyte.

Further, in some embodiments, 10 N/m≥F₂≥4 N/m. The lower limit value of F₂ is defined, so that the interfaces between the first inner electrode sheet 21b, the second separator 23b, and the corresponding second electrode sheet 22 can be enhanced, and the risk of lithium precipitation after long-term charge-discharge cycles can be reduced. The lower limit value of F₂ is defined, reducing the risk of excessive interface bonding between the first inner electrode sheet 21b, the second separator 23b, and the corresponding second electrode sheet 22, reducing the risk that excessive F₁ leads to excessive interface bonding between the first outer electrode sheet 21a, the first separator 23a, and the corresponding second electrode sheet 22, thereby reducing the risk of capacity decay caused by lithium precipitation, black spots, and the like induced by untimely electrolyte replenishment.

Refer to FIG. 6. In some other embodiments, a connection section 233 is further provided between each two adjacent second separators 23b. That is, the plurality of second separators 23b are connected to each other through the connection section 233 to form an integral structure. The plurality of second separators 23b substantially form a Z-shaped structure by alternately bending and folding in positive and negative directions. Due to the provision of the connection section 233, the second separator 23b can bind the first inner electrode sheet 21b and the second electrode sheet 22.

Refer to FIG. 7 to FIG. 9. Another embodiment of this application further provides a secondary battery 200. The difference from the above secondary battery 100 is that, as shown in FIG. 8, in some embodiments, a first electrode sheet 21 is a negative electrode sheet, and a second electrode sheet 22 is a positive electrode sheet.

As shown in FIG. 9, in some other embodiments, the first outer electrode sheet 21a may also be an electrode sheet with two sides coated. The first outer electrode sheet 21a includes a first active material layer 211, a first current collector 210, and a second active material layer 212 stacked in the first direction X. The first current collector 210 includes a first surface 210a facing the second electrode sheet 22 and a second surface 210b opposite to the first surface 210a. The first active material layer 211 is disposed on the first surface 210a, and the second active material layer 212 is disposed on the second surface 210b.

The secondary batteries 100 and 200 in this application may be lithium secondary batteries, including lithium metal secondary batteries, lithium-ion secondary batteries, lithium polymer secondary batteries, and lithium-ion polymer secondary batteries.

Refer to FIG. 10. An embodiment of this application further provides an electronic apparatus 1, including the above secondary battery 100 (or secondary battery 200). The electronic apparatus 1 is powered by the above secondary battery 100, and the risk of lithium precipitation in the secondary battery 100 is reduced. In some embodiments, the electronic apparatus 1 in this application may be, but is not limited to, a notebook computer, a pen-input computer, a mobile computer, an e-book player, a portable phone, a portable fax machine, a portable copier, a portable printer, a head-mounted stereo headphone, a video recorder, a liquid crystal television, a handheld cleaner, a portable CD player, a mini disc, a transceiver, an electronic organizer, a calculator, a memory card, a portable recorder, a radio, a backup power supply, a motor, a car, a motorcycle, an electric bicycle, a bicycle, a lighting fixture, a toy, a game console, a clock, an electric tool, a flash, a camera, a home large-capacity battery, a lithium-ion capacitor, and the like.

The performance of the secondary battery provided in this application is illustrated below through specific examples and comparative examples. This application is illustrated by using an example in which the secondary battery is a lithium-ion pouch battery, a first electrode sheet is a positive electrode sheet, and a second electrode sheet is a negative electrode sheet and based on specific preparation processes and test methods. Those skilled in the art should understand that the preparation methods described in this application are only examples, and any other suitable preparation methods are within the scope of this application.

### Example 1

(1) Preparation of positive electrode sheet: A positive electrode active material lithium cobaltate (LiCoO₂), conductive carbon black (Super P), and polyvinylidene fluoride (PVDF) were mixed in a weight ratio of 97.5:1.0:1.5; and N-methylpyrrolidone (NMP) was added as a solvent, to obtain a slurry with a solid content of 75 wt %, which was stirred uniformly. The slurry was uniformly applied to one surface of a positive electrode current collector aluminum foil with a thickness of 12 μm, with an empty foil area reserved in advance at the edge of the aluminum foil, and then dried at 90° C. to obtain a positive electrode sheet with a positive electrode active material layer thickness of 100 μm. The positive electrode sheet with one side coated was subsequently used as a first outer electrode sheet. To prepare another first electrode sheet with two sides coated (such as first inner electrode sheet), the above coating steps were repeated on another surface of the aluminum foil. Then, the excess empty foil area was cut off through laser die-cutting to obtain a positive electrode tab.
(2) Preparation of negative electrode sheet: A negative electrode active material artificial graphite, conductive carbon black (Super P), and styrene-butadiene rubber (SBR) were mixed in a weight ratio of 96:1.5:2.5, and deionized water was added as a solvent, to obtain a slurry with a weight percentage of 70 wt %, which was stirred uniformly. The slurry was uniformly applied to one surface of a negative electrode current collector copper foil with a thickness of 10 μm, with an empty foil area reserved in advance at the edge of the copper foil, and then dried at 110° C. to obtain a negative electrode sheet with one side coated with a negative electrode active material layer, where a coating thickness was 150 μm. The above steps were repeated on another surface of the negative electrode sheet to obtain a negative electrode sheet with two sides coated with negative electrode active material layers. Then, excess empty foil area was cut off through laser die-cutting to obtain a negative electrode tab.
(3) Preparation of electrolyte: In a dry argon atmosphere, organic solvents ethylene carbonate (EC), ethyl methyl carbonate (EMC), and diethyl carbonate (DEC) were first mixed in a mass ratio of EC:EMC:DEC=30:50:20, then lithium salt lithium hexafluorophosphate (LiPF₆) was added to the organic solvent, dissolved, and mixed uniformly to obtain an electrolyte with a lithium salt concentration of 1.15 mol/L.
(4) Preparation of first separator: A three-layer structure separator was used, including a first bonding layer, a first substrate layer, and a third bonding layer that were stacked. A material of the first substrate layer was polyethylene (PE), a first binder in the first bonding layer and a third binder in the third bonding layer were both PVDF, and the first bonding layer and the second bonding layer further included inorganic ceramic particles Al₂O₃. A mass content of the first binder in the first bonding layer was 9%, and a mass content of the third binder in the third bonding layer was 8%.
(5) Preparation of second separator: A three-layer structure separator was used, including a second bonding layer, a second substrate layer, and a fourth bonding layer that were stacked. A material of the second substrate layer was polyethylene (PE), a second binder in the second bonding layer and a fourth binder in the fourth bonding layer were both PVDF, and a second bonding layer and a fourth bonding layer further included inorganic ceramic particles Al₂O₃. A mass content of the second binder in the second bonding layer and a mass content of the fourth binder in the fourth bonding layer were both 8%.
(6) Preparation of electrode assembly: Except a first outer electrode sheet, a positive electrode sheet, a second separator, and a negative electrode sheet were stacked, and two first separators were placed on two opposite sides of the above structure to form an electrode assembly with a stacking structure. The stacking structure was hot pressed by a flat plate at a temperature of 80° C. and a pressure of 1.5 MPa for 10 seconds. Then, two first outer electrode sheets were stacked on two opposite sides of the above structure obtained through the first hot pressing step, and then hot pressed by the flat plate at a temperature of 80° C. and a pressure of 1.5 MPa for 10 seconds.
(7) Assembly of secondary battery: A positive electrode tab and a negative electrode tab were welded to a first conductive plate and a second conductive plate through adapter welding. A material of the first conductive plate was aluminum, and a material of the second conductive plate was nickel. Then, the electrode assembly was placed in an aluminum-plastic film packaging bag; the first conductive plate and the second conductive plate both extended beyond the packaging bag; and after drying, an electrolyte was injected. A secondary battery was obtained through processes such as vacuum packaging, standing, formation, degassing, and trimming.

### Examples 2 to 7

A difference from Example 1 was that the mass content of the first binder in the first bonding layer was increased, so the bonding strength F₁ of the first separator was different from that in Example 1.

### Examples 8 to 10

A difference from Example 3 was that the mass content of the first binder in the first bonding layer and the mass content of the second binder in the second bonding layer were both increased, so the bonding strength F₁ of the first separator and the bonding strength F₂ of the second separator were different from those in Example 3.

### Comparative Example 1

The difference from Example 1 was that all separators had the same structure and composition as the second separator.

### Comparative Example 2

The difference from Comparative example 1 was that in the separator bonded to the first outer electrode sheet, the mass content of the first binder in the first bonding layer was reduced, so the bonding strength F₁ of the separator was different from that in Comparative example 1.

### Comparative Example 3

The difference from Comparative example 1 was that the mass content of the first binder in the first bonding layer and the mass content of the second binder in the second bonding layer were both reduced, so the bonding strength F₁ of the first separator and the bonding strength F₂ of the second separator were different from those in Comparative example 1.

Cycling test was performed on the batteries in comparative examples and examples. The cycling test steps were as follows: (1) The battery was placed in a 25° C. constant temperature box and left standing for 30 minutes to enable the battery to reach a constant temperature. (2) The battery was charged, specifically, the battery was charged at a constant current of 0.7C to full charge voltage, discharged at a constant voltage to 0.05C, and then discharged at a constant current of 0.5C to 3.0V. This was one charge-discharge cycle, and an initial discharge capacity was 100%, 300 charge-discharge cycles were repeated. (3) Whether surface abnormalities, such as bumps, occurred on a surface of the secondary battery was observed, and the electrode assembly was disassembled to observe whether black spots or lithium precipitation occurred on the surface of the negative electrode sheet. The results were recorded in Table 1.

It can be understood that since the bonding strengths of all separators in Comparative examples 1 and 2 were the same, no distinction is made between the first separator and the second separator, and in the columns corresponding to the comparative examples in Table 1, the first separator and the second separator are only used to distinguish separators at different positions in the electrode assembly.

TABLE 1

| | First separator | | | Second separator | | | | | |
|---|---|---|---|---|---|---|---|---|---|
| | | Content | | | Content | | | Cycling test result | |
| | Type of | of first | | Type of | of second | | Relationship | | Lithium |
| | first | binder | F₁ | second | binder | F₂ | between F₁ | Surface | precipitation |
| | binder | (wt %) | (N/m) | binder | (wt %) | (N/m) | and F₂ | abnormality | or black spots |
| Comparative | PVDF | 8% | 4 | PVDF | 8% | 4 | F₁ = F₂ | Bumps after | Lithium |
| example 1 | | | | | | | | 120 cls | precipitation |
| | | | | | | | | | and black spots |
| | | | | | | | | | on outer |
| | | | | | | | | | electrode sheet |
| | | | | | | | | | after 120 cls |
| Comparative | PVDF | 7.5% | 3.9 | PVDF | 8% | 4 | F₁ < F₂ | Bumps after | Lithium |
| example 2 | | | | | | | | 50 cls | precipitation |
| | | | | | | | | | and black spots |
| | | | | | | | | | on outer |
| | | | | | | | | | electrode sheet |
| | | | | | | | | | after 50 cls |
| Comparative | PVDF | 7.5% | 3.9 | PVDF | 7.5% | 3.9 | F₁ = F₂ | Bumps after | Lithium |
| example 3 | | | | | | | | 100 cls | precipitation |
| | | | | | | | | | and black spots |
| | | | | | | | | | on outer |
| | | | | | | | | | electrode sheet |
| | | | | | | | | | after 100 cls |
| Example 1 | PVDF | 9% | 4.4 | PVDF | 8% | 4 | F₁ = 1.1F₂ | Bumps after | Lithium |
| | | | | | | | | 270 cls | precipitation |
| | | | | | | | | | and black spots |
| | | | | | | | | | on outer |
| | | | | | | | | | electrode sheet |
| | | | | | | | | | after 270 cls |
| Example 2 | PVDF | 10% | 4.8 | PVDF | 8% | 4 | F₁ = 1.2F₂ | Bumps after | Lithium |
| | | | | | | | | 300 cls | precipitation |
| | | | | | | | | | and black spots |
| | | | | | | | | | on outer |
| | | | | | | | | | electrode sheet |
| | | | | | | | | | after 300 cls |
| Example 3 | PVDF | 12% | 6 | PVDF | 8% | 4 | F₁ = 1.5F₂ | No | No |
| | | | | | | | | abnormality | abnormality |
| Example 4 | PVDF | 14% | 8 | PVDF | 8% | 4 | F₁ = 2F₂ | No | No |
| | | | | | | | | abnormality | abnormality |
| Example 5 | PVDF | 16% | 12 | PVDF | 8% | 4 | F₁ = 3F₂ | No | No |
| | | | | | | | | abnormality | abnormality |
| Example 6 | PVDF | 18% | 16 | PVDF | 8% | 4 | F₁ = 4F₂ | No | No |
| | | | | | | | | abnormality | abnormality |
| Example 7 | PVDF | 18.5% | 16.4 | PVDF | 8% | 4 | F₁ = 4.1F₂ | Bumps after | Lithium |
| | | | | | | | | 300 cls | precipitation |
| | | | | | | | | | and black spots |
| | | | | | | | | | on outer |
| | | | | | | | | | electrode sheet |
| | | | | | | | | | after 300 cls |
| Example 8 | PVDF | 16% | 12 | PVDF | 14% | 8 | F₁ = 1.5F₂ | No | No |
| | | | | | | | | abnormality | abnormality |
| Example 9 | PVDF | 17% | 15 | PVDF | 15% | 10 | F₁ = 1.5F₂ | No | No |
| | | | | | | | | abnormality | abnormality |
| Example 10 | PVDF | 18.6% | 16.5 | PVDF | 15.2% | 11 | F₁ = 1.5F₂ | Bumps after | Lithium |
| | | | | | | | | 300 cls | precipitation |
| | | | | | | | | | and black spots |
| | | | | | | | | | on outer |
| | | | | | | | | | electrode sheet |
| | | | | | | | | | after 300 cls |

From the test results in Table 1, compared with Comparative example 1, in Comparative example 3, the bonding strength of the separator was less than 4 N/m, so the interface between the electrode sheet and the separator was poor after hot pressing, and lithium precipitation and black spots were more likely to occur after cycling.

Compared with Comparative examples 1 and 2, in Example 1, the bonding strength F₁ between the first separator and the first outer electrode sheet is increased, enhancing the interface between the first outer electrode sheet, the first separator, and the corresponding second electrode sheet after hot pressing, reducing the risk of lithium precipitation after long-term charge-discharge cycles. Compared with Example 1, in Examples 2 to 7, the bonding strength F₁ is increased, further enhancing the interface between the first outer electrode sheet, the first separator, and the corresponding second electrode sheet after hot pressing, further reducing the risk of lithium precipitation after long-term charge-discharge cycles. In Examples 3 to 5, 4F₂≥F₁≥1.5F₂ is satisfied, which not only further enhanced the interface between the first outer electrode sheet, the first separator, and the corresponding second electrode sheet, but also reduced the risk of excessive interface bonding between the first outer electrode sheet, the first separator, and the corresponding second electrode sheet or blocking the pores of the first separator by excessive first binder, so the risk of lithium precipitation after long-term charge-discharge cycles was further reduced. In Examples 3 and 8 to 10, F₁=1.5F₂ is satisfied, but in Example 10, F₂>10 N/m, so the value of F₁ is larger, leading to larger interface bonding between the first outer electrode sheet, the first separator, and the corresponding second electrode sheet, increasing the risk of lithium precipitation after long-term charge-discharge cycles due to larger interface bonding between the first outer electrode sheet, the first separator, and the corresponding second electrode sheet.

### Examples 11 to 17 and Comparative Example 4

A difference from Example 1 was that both the first binder and the second binder were a vinylidene fluoride-hexafluoropropylene (PVDF-HFP) copolymer.

Cycling tests were performed on the batteries in comparative examples and examples according to the same test method, and the results were recorded in Table 2.

TABLE 2

| | First separator | | | Second separator | | | | | |
|---|---|---|---|---|---|---|---|---|---|
| | | Content | | | Content | | | Cycle test results | |
| | Type of | of first | | Type of | of second | | Relationship | | Lithium |
| | first | binder | F₁ | second | binder | F₂ | between F₁ | Surface | precipitation |
| | binder | (wt %) | (N/m) | binder | (wt %) | (N/m) | and F₂ | abnormality | or black spots |
| Comparative | PVDF- | 6% | 4 | PVDF- | 6% | 4 | F₁ = F₂ | Bumps after | Lithium |
| example 4 | HFP | | | HFP | | | | 140 cls | precipitation |
| | | | | | | | | | and black spots |
| | | | | | | | | | on outer |
| | | | | | | | | | electrode sheet |
| | | | | | | | | | after 140 cls |
| Example 11 | PVDF- | 7% | 4.4 | PVDF- | 6% | 4 | F₁ = 1.1F₂ | Bumps after | Lithium |
| | HFP | | | HFP | | | | 280 cls | precipitation |
| | | | | | | | | | and black spots |
| | | | | | | | | | on outer |
| | | | | | | | | | electrode sheet |
| | | | | | | | | | after 280 cls |
| Example 12 | PVDF- | 8% | 4.8 | PVDF- | 6% | 4 | F₁ = 1.2F₂ | Bumps after | Lithium |
| | HFP | | | HFP | | | | 300 cls | precipitation |
| | | | | | | | | | and black spots |
| | | | | | | | | | on outer |
| | | | | | | | | | electrode sheet |
| | | | | | | | | | after 300 cls |
| Example 13 | PVDF- | 9% | 6 | PVDF- | 6% | 4 | F₁ = 1.5F₂ | No | No |
| | HFP | | | HFP | | | | abnormality | abnormality |
| Example 14 | PVDF- | 10% | 8 | PVDF- | 6% | 4 | F₁ = 2F₂ | No | No |
| | HFP | | | HFP | | | | abnormality | abnormality |
| Example 15 | PVDF- | 11% | 12 | PVDF- | 6% | 4 | F₁ = 3F₂ | No | No |
| | HFP | | | HFP | | | | abnormality | abnormality |
| Example 16 | PVDF- | 12% | 16 | PVDF- | 6% | 4 | F₁ = 4F₂ | No | No |
| | HFP | | | HFP | | | | abnormality | abnormality |
| Example 17 | PVDF- | 12.50% | 16.4 | PVDF- | 6% | 4 | F₁ = 4.1F₂ | Bumps after | Lithium |
| | HFP | | | HFP | | | | 300 cls | precipitation |
| | | | | | | | | | and black spots |
| | | | | | | | | | on outer |
| | | | | | | | | | electrode sheet |
| | | | | | | | | | after 300 cls |

From the test results in Table 2, compared with Comparative example 4, in Example 11, the bonding strength F₁ between the first separator and the first outer electrode sheet is increased, enhancing the interface between the first outer electrode sheet, the first separator, and the corresponding second electrode sheet after hot pressing, reducing the risk of lithium precipitation after long-term charge-discharge cycles. Compared with Example 11, in Examples 12 to 17, the bonding strength F₁ is increased, further enhancing the interface between the first outer electrode sheet, the first separator, and the corresponding second electrode sheet after hot pressing, further reducing the risk of lithium precipitation after long-term charge-discharge cycles. In Examples 13 to 16, 4F₂≥F₁≥1.5F₂ is satisfied, further reducing the risk of lithium precipitation after long-term charge-discharge cycles.

It can be understood that the instance of Table 1 where both the first binder and the second binder are PVDF, and the instance of Table 2 where both the first binder and the second binder are PVDF-HFP are used to illustrate the examples and comparative examples of this application, but those skilled in the art can foresee that when the first binder and the second binder are both changed to other types of binders, the principle of action in this application is similar, and is also applicable in this application.

### Examples 18 to 21 and Comparative Example 5

A difference from Example 1 was that the first binder and the second binder adopted different components respectively, which were specifically recorded in Table 3.

Cycling tests were performed on the batteries in the comparative examples and examples according to the same test method, and the results were recorded in Table 3.

TABLE 3

| | First separator | | | Second separator | | | | | |
|---|---|---|---|---|---|---|---|---|---|
| | | Content | | | Content | | | Cycle test results | |
| | Type of | of first | | Type of | of second | | Relationship | | Lithium |
| | first | binder | F₁ | second | binder | F₂ | between F₁ | Surface | precipitation |
| | binder | (wt %) | (N/m) | binder | (wt %) | (N/m) | and F₂ | abnormality | or black spots |
| Comparative | PVDF- | 6.5% | 4 | PVDF | 8% | 4 | F₁ = F₂ | Bumps after | Lithium |
| example 5 | HFP | | | | | | | 80 cls | precipitation |
| | | | | | | | | | and black spots |
| | | | | | | | | | on outer |
| | | | | | | | | | electrode sheet |
| | | | | | | | | | after 80 cls |
| Example 18 | PVDF- | 8% | 4.8 | PVDF | 8% | 4 | F₁ = 1.2F₂ | Bumps after | Lithium |
| | HFP | | | | | | | 300 cls | precipitation |
| | | | | | | | | | and black spots |
| | | | | | | | | | on outer |
| | | | | | | | | | electrode sheet |
| | | | | | | | | | after 300 cls |
| Example 19 | PVDF- | 12.5% | 10 | PVDF | 8% | 4 | F₁ = 2.5F₂ | No | No |
| | HFP | | | | | | | abnormality | abnormality |
| Example 20 | PMMA | 8% | 6 | PVDF | 8% | 4 | F₁ = 1.5F₂ | No | No |
| | | | | | | | | abnormality | abnormality |
| Example 21 | PI | 17.3% | 14 | PVDF | 8% | 4 | F₁ = 3.5F₂ | No | No |
| | | | | | | | | abnormality | abnormality |

From the test results in Table 3, it can be learned that the examples of this application are not limited to the case where the first binder and the second binder both adopt the same component. As in Examples 18 and 19, the first binder in the first bonding layer is PVDF-HFP, and the second binder in the second bonding layer is PVDF. As in Example 20, the first binder in the first bonding layer is polymethyl methacrylate (PMMA), and the second binder in the second bonding layer is PVDF. As in Example 21, the first binder in the first bonding layer is polyimide (PI), and the second binder in the second bonding layer is PVDF. Compared with Comparative example 5, since F₁>F₂ is satisfied in Examples 18 to 21, the interface between the first outer electrode sheet, the first separator, and the corresponding second electrode sheet was similarly enhanced after hot pressing, reducing the risk of lithium precipitation after long-term charge-discharge cycles.

The above disclosures are merely preferred embodiments of this application, and certainly, cannot be used to limit this application. Therefore, equivalent changes made according to this application still fall within the scope covered by this application.

What is claimed is:

1. A secondary battery, comprising an electrode assembly, wherein the electrode assembly has a stacked structure, the electrode assembly comprises first electrode sheets, separators, and second electrode sheets stacked in a first direction, wherein
the first electrode sheets comprise a first outer electrode sheet located at an outermost end of the electrode assembly in the first direction and at least one first inner electrode sheet located inside the electrode assembly relative to the first outer electrode sheet; and the separators comprise a first separator bonded to the first outer electrode sheet and a second separator bonded to the at least one first inner electrode sheet; and
a bonding strength between the first separator and the first outer electrode sheet is defined as F₁, a bonding strength between the second separator and the at least one first inner electrode sheet is defined as F₂, and F₁>F₂.

2. The secondary battery according to claim 1, wherein F₁≥1.2F₂.

3. The secondary battery according to claim 2, wherein 4F₂≥F₁≥1.5F₂.

4. The secondary battery according to claim 3, wherein 10 N/m≥F₂≥4 N/m.

5. The secondary battery according to claim 1, wherein the first separator comprises a first substrate layer and a first bonding layer stacked in the first direction, the first bonding layer is disposed facing the first outer electrode sheet, the second separator comprises a second substrate layer and a second bonding layer stacked in the first direction, the second bonding layer is disposed facing the at least one first inner electrode sheet, a first binder is provided in the first bonding layer, and a second binder is provided in the second bonding layer.

6. The secondary battery according to claim 5, wherein the first binder and the second binder are of a same type, and a mass content of the first binder in the first bonding layer is greater than a mass content of the second binder in the second bonding layer.

7. The secondary battery according to claim 5, wherein the first binder and the second binder are independently selected from one or a combination of polyvinylidene fluoride, vinylidene fluoride-hexafluoropropylene copolymer, polyamide, polyacrylonitrile, polyacrylate ester, polyacrylic acid, polyacrylate salt, polyvinylpyrrolidone, polyvinyl ether, polymethyl methacrylate, polytetrafluoroethylene, or polyhexafluoropropylene.

8. The secondary battery according to claim 5, wherein materials of the first substrate layer and the second substrate layer are independently at least one selected from the group consisting of polyolefin, polyvinylidene fluoride, polyethylene terephthalate, cellulose, polyimide, polyamide, spandex, and poly(phenylene phthalamide).

9. The secondary battery according to claim 5, wherein at least one of the first bonding layer or the second bonding layer further comprises inorganic particles; and the inorganic particles are at least one selected from the group consisting of aluminum oxide, silicon oxide, magnesium oxide, titanium oxide, hafnium dioxide, tin oxide, cerium dioxide, nickel oxide, zinc oxide, calcium oxide, zirconium oxide, yttrium oxide, silicon carbide, boehmite, aluminum hydroxide, magnesium hydroxide, calcium hydroxide, and barium sulfate.

10. The secondary battery according to claim 9, wherein the first electrode sheets are positive electrode sheets.

11. The secondary battery according to claim 1, wherein the first outer electrode sheet comprises a first current collector and a first active material layer stacked in the first direction, the first current collector comprises a first surface facing one of the second electrode sheets and a second surface opposite to the first surface, the first active material layer is disposed on the first surface, and the second surface is not provided with any active material.

12. The secondary battery according to claim 1, wherein each separator further comprises a connection section disposed between adjacent second separators, and the second separators are connected to each other through the connection section to form an integral structure.

13. The secondary battery according to claim 5, wherein the first separator further comprises a third bonding layer stacked with the first substrate layer and the first bonding layer in the first direction, the third bonding layer facing the second electrode sheet.

14. The secondary battery according to claim 5, wherein the second separator further comprises a fourth bonding layer stacked with the second substrate layer and the second bonding layer in the first direction, the fourth bonding layer facing the second electrode sheet.

15. The secondary battery according to claim 6, wherein the mass content of the first binder in the first bonding layer is in a range of 9 wt % to 18 wt %.

16. The secondary battery according to claim 1, wherein each first electrode sheet is a positive electrode sheet, and each second electrode sheet is a negative electrode sheet.

17. An electronic apparatus, comprising the secondary battery according to claim 1.

18. The electronic apparatus according to claim 17, wherein F₁≥1.2F₂.

19. The electronic apparatus according to claim 18, wherein 4F₂≥F₁≥1.5F₂

20. The electronic apparatus according to claim 19, wherein 10 N/m≥F₂≥4 N/m.
